(19) United States
(12) Patent Application Publication
(10) Pub. No.: US 2020/0016032 A1
(43) Pub. Date: Jan. 16, 2020

(54) AURICULOTHERAPY DEVICE

(71) Applicant: Ashley Frer, Chicago, IL (US)

(72) Inventor: Ashley Frer, Chicago, IL (US)

(21) Appl. No.: 16/509,080

(22) Filed: Jul. 11, 2019

Related U.S. Application Data
(60) Provisional application No. 62/698,554, filed on Jul. 16, 2018.

(51) Int. Cl. A61H 39/04

(52) U.S. Cl. CPC A61H 39/04; A61H 2205/027

(57) ABSTRACT

A device and method for providing auriculotherapy are disclosed. The device has a base and first side. The first side of the device contains a plurality of therapeutic projections which engage acupressure points of the ear. The device is fitted to the ear such that the therapeutic projections provide constant stimulation of the desired acupressure point.

### CROSS-REFERENCE

This application claims priority from U.S. Provisional Application No. 62/698,554, filed on Jul. 16, 2018.

### FIELD OF THE INVENTION

The invention relates to acupressure-based therapeutic devices. More specifically, the invention relates to auriculotherapy devices which engage the acupressure points of the ear to provide therapeutic relief.

### BACKGROUND OF THE INVENTION

Non-Western and holistic medicine practices have existed for thousands of years. These practices compliment or are alternatives to conventional Western medicine. Examples of such practices include acupuncture and acupressure techniques.

Acupressure is a practice that seeks to stimulate nerve connections in the body through application of physical pressure to known acupressure points. Unlike acupuncture, acupressure treatments do not require the insertion of needles into the skin or other invasive procedures. Acupressure can be applied to various parts of the body, including the ear.

Acupressure of the ear, also known as auricular acupressure or auriculotherapy, was first popularized in the West by Dr. Paul Nogier. Practitioners of auriculotherapy apply pressure to various points on the external ear. The stimulation triggers a therapeutic response, which can treat various ailments and disorders. The fundamentals of auriculotherapy are summarized in the World Health Organizations “Report of the Working Group on Auricular Acupuncture Nomenclature” (Lyon, France 1990) which is hereby incorporated by reference. Auriculotherapy has been widely studied and documented in numerous medical journals, such as Europ. J. Integrative Med. 2016 October: 817-834, and Evid. Based Complement. Alternat. Med. 2007 September; 4(Suppl. 1): 13-16, which are also hereby incorporated by reference.

Auriculotherapy devices are disclosed in U.S. Patent Application Publication No. 2009/0235688, as well as U.S. Pat. No. 5,735,143. While the prior art discloses protrusions that stimulate acupressure points on the ear, the disclosed protrusions do not accommodate the contours of the ear. As such the stimulative effect of the protrusions on the ear's acupressure points is limited. Additionally, given the small size of the ear, the acupressure points in the ear are correspondingly small. Despite this, the prior art utilizes at most ten protrusions for a given area of the ear, limiting the amount each pressure point in the ear can be engaged.

What is needed is an auriculotherapy device which can effectively engage the contours and small size of the acupressure points of the ear, maximizing the stimulation of the ear's acupressure points.

### SUMMARY OF THE INVENTION

In accordance with one aspect of the invention, there is provided a device for providing therapeutic pressure to an ear. The device has a base having a first side, and therapeutic projections extend from the first side of the base.

In accordance with a further aspect of the invention, the base provides for two or more rows of therapeutic projections, wherein each of the rows of projections vary in height to engage the contours of the ear. The amount of therapeutic projections ensures that a large surface area of the ear, and in turn a large surface area of the corresponding acupressure point, is engaged.

### BRIEF DESCRIPTION OF THE FIGURES

FIG. 1 is a diagram depicting the anatomy of the ear.

FIG. 2 is a diagram further depicting the anatomy of the ear.

FIG. 3 is a diagram further depicting the anatomy of the ear.

FIG. 4 is a diagram further depicting the anatomy of the ear.

FIG. 5 is a diagram further depicting the anatomy of the ear.

FIG. 6A is a diagram depicting the embryonic endodermic germ layers of an early fetus, for comparison to the zones of the ear targeted in auriculotherapy.

FIG. 6B is a diagram depicting the embryonic endodermic germ layers of a late fetus, for comparison to the zones of the ear targeted in auriculotherapy.

FIG. 6C is a diagram depicting the zones of the ear targeted in auriculotherapy, for comparison to human embryonic development.

FIG. 7 is a diagram depicting the zones of the ear targeted in auriculotherapy that correspond to portions of the body developed in the embryonic endodermic germ layer.

FIG. 8 is a diagram further depicting the zones of the ear targeted in auriculotherapy that correspond to portions of the body developed in the embryonic endodermic germ layer.

FIG. 9 is a diagram depicting the zones of the ear targeted in auriculotherapy that correspond to portions of the body developed in the embryonic mesodermic germ layer.

FIG. 10 is a diagram further depicting the zones of the ear targeted in auriculotherapy that correspond to portions of the body developed in the embryonic mesodermic germ layer.

FIG. 11 is a diagram depicting the zones of the ear targeted in auriculotherapy that correspond to portions of the body developed in the embryonic mesodermic germ layer.

FIG. 12 is a diagram further depicting the zones of the ear targeted in auriculotherapy that correspond to portions of the body developed in the embryonic mesodermic germ layer.

FIG. 13 is a diagram further depicting the zones of the ear targeted in auriculotherapy that correspond to portions of the body developed in the embryonic ectodermic germ layer.

FIG. 14 is a diagram further depicting the zones of the ear targeted in auriculotherapy that correspond to portions of the body developed in the embryonic ectodermic germ layer.

FIG. 15 is a diagram depicting a three-quarters view of one preferred embodiment of the invention.

FIG. 16 is a diagram depicting a top-down view of one side of one preferred embodiment of the claimed invention.

FIG. 17 is a diagram depicting a single therapeutic projection.

FIG. 18 is a diagram depicting a three-quarters view of the opposite side of one preferred embodiment of the claimed invention.

FIG. 19 is a diagram depicting a top-down view of a second preferred embodiment of the claimed invention.

FIG. 20 is a diagram depicting a three-quarters view of a third preferred embodiment of the claimed invention.

FIG. 21 is a diagram depicting a top-down view of a third preferred embodiment of the claimed invention.

### DETAILED DESCRIPTION OF THE PREFERRED EMBODIMENTS

In accordance with one aspect of the invention, there is provided a device for delivering therapeutic pressure to an ear. The device has a base having a first side, and therapeutic projections extend from the first side of the base.

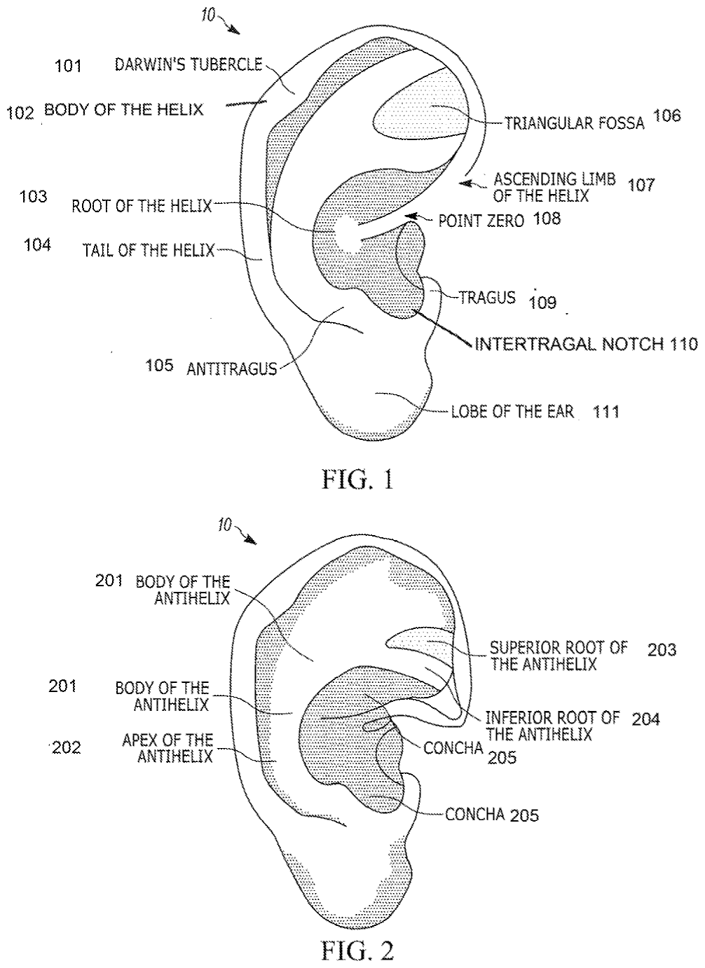

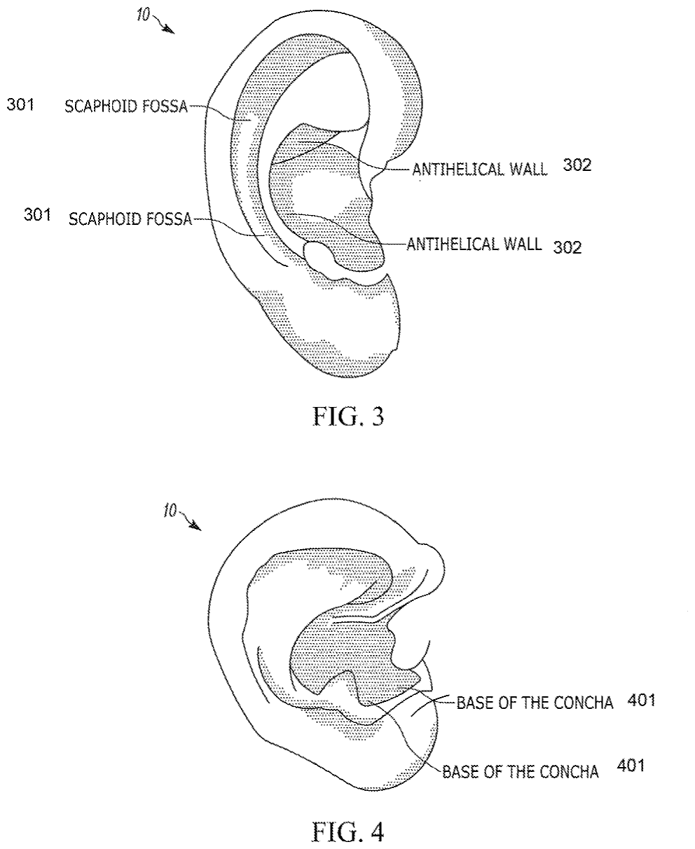

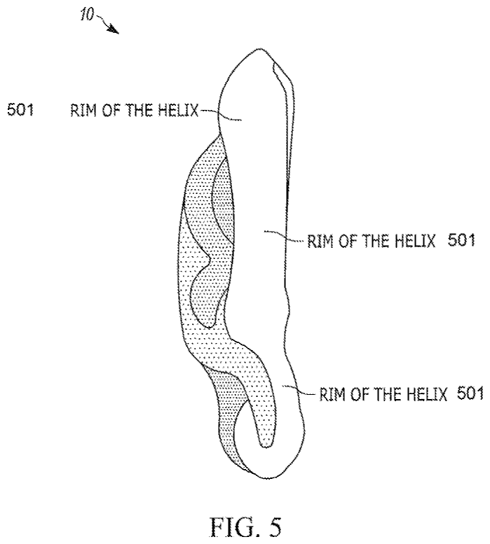

Turning to the Figures, wherein like parts are designated with like numerals throughout several views, the anatomy of the ear 10 is depicted in FIGS. 1-5. Specifically, FIG. 1 discloses the Darwin's Tubercle 101, the Body of the Helix 102, the Root of the Helix 103, the Tail of the Helix 104, the Antitragus, 105, the Navicular/Triangular Fossa 106, the Ascending Limb of the Helix 107, Point Zero 108, the Tragus 109, the Intertragal Notch 110, and the Lobe of the Ear 111. FIG. 2 discloses the Body of the Antihelix 201, the Apex of the Antihelix 202, the Superior Root of the Antihelix 203, the Inferior Root of the Antihelix 204, and the Concha 205. FIG. 3 discloses the Scaphoid Fossa 301 and the Antihelical Wall 302. FIG. 4 discloses the Base of the Concha 401. FIG. 5 discloses the Rim of the Helix 501.

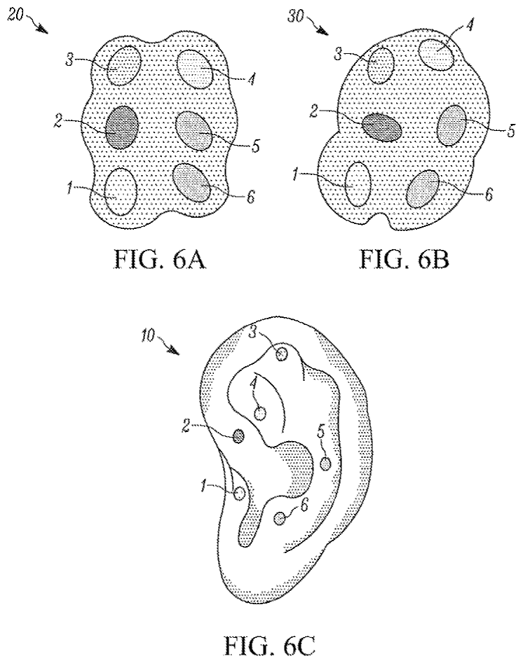

It was determined by Dr. Nogier and other auriculotherapy researchers that the embryological germ layers of a human fetus mirror the anatomy of the ear. As FIGS. 6A-6C show, the cellular development of an early fetus 20 and late fetus 30 can be mapped onto auriculotherapy zones of the ear 10. As FIG. 6C shows, auriculotherapy zone 1 of ear 10 includes the tragus 109. Zone 2 includes the concha 205, including the upper concha and base of the concha 401. Zone 3 includes the anatomies of the helix, including the root of the helix 103, the ascending limb of the helix 107, the body of the helix 102, and the tail of the helix 104. Zone 4 includes the anatomies of the anti-helix 201, including the middle third, lower third, and apex upper third 202, the scaphoid fossa 301, the navicular/triangular fossa 106, and the superior root of the antihelix 204. Zone 5 includes the anatomies of the antitragus 105, including the inter tragal notch 110; and zone 6 includes the lobe of the ear 111.

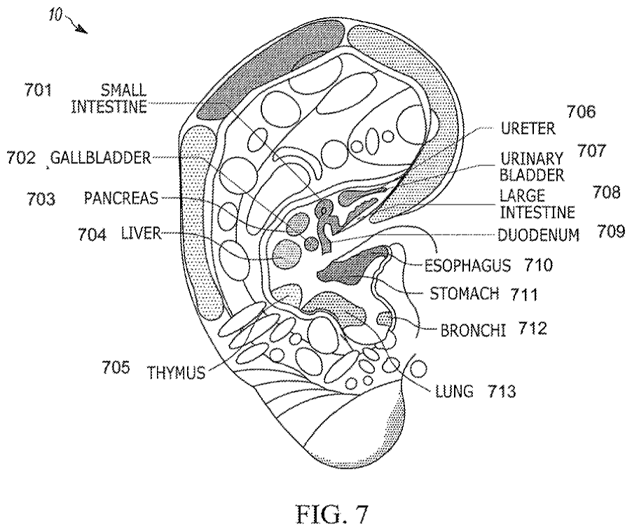

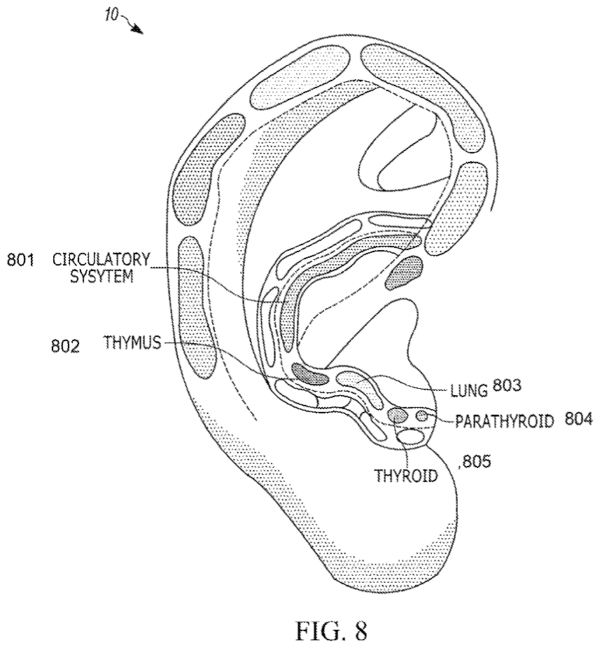

It has been determined that treatments to the zones of the ear have a corresponding therapeutic effect to physiologies of the body that develop from the embryological germ layers that mirror the zones of the ear. For example, FIGS. 7 and 8 disclose treatments on zones 2, 3, and 5, of the ear as depicted in FIG. 6C, that correspond to portions of the body developed in the embryonic endodermic germ layer. Specifically, FIG. 7 discloses a section of the ear 701 that treats the small intestine; a section 702 that treats the gallbladder; a section 703 that treats the pancreas; a section 704 that treats the liver; a section 705 that treats the Thymus; a section 706 that treats the ureter; a section 707 that treats the urinary bladder; a section 708 that treats the large intestine; a section 709 that treats the duodenum; a section 710 that treats the esophagus; a section 711 that treats the stomach; a section 712 that treats the bronchi; and a section 713 that treats the lung. FIG. 8 discloses a section of the ear 801 that treats the circulatory system; a section 802 that treats the thymus; a section 803 that treats the lung; a section 804 that treats the parathyroid, and a section 805 that treats the thyroid.

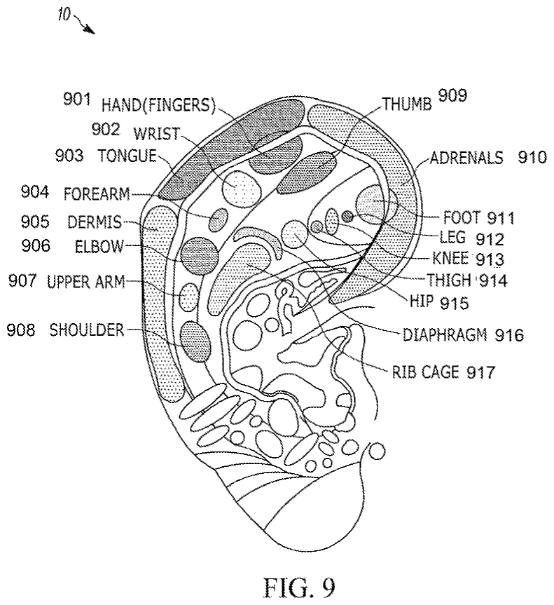

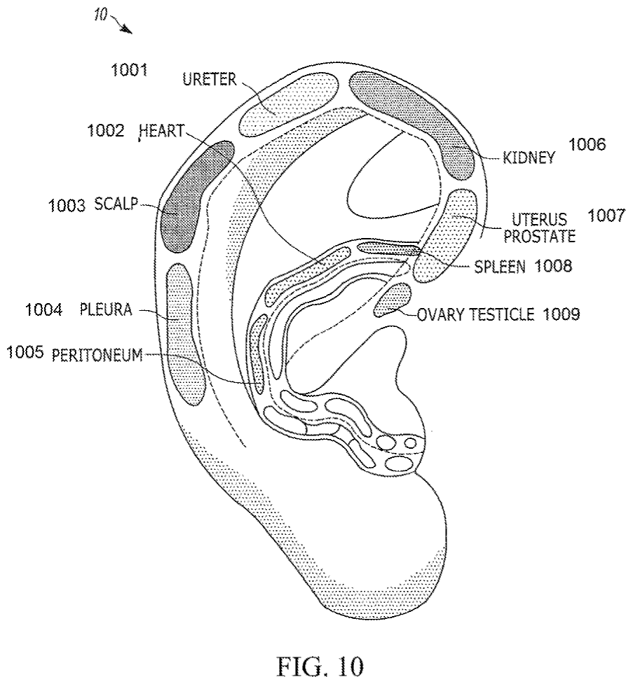

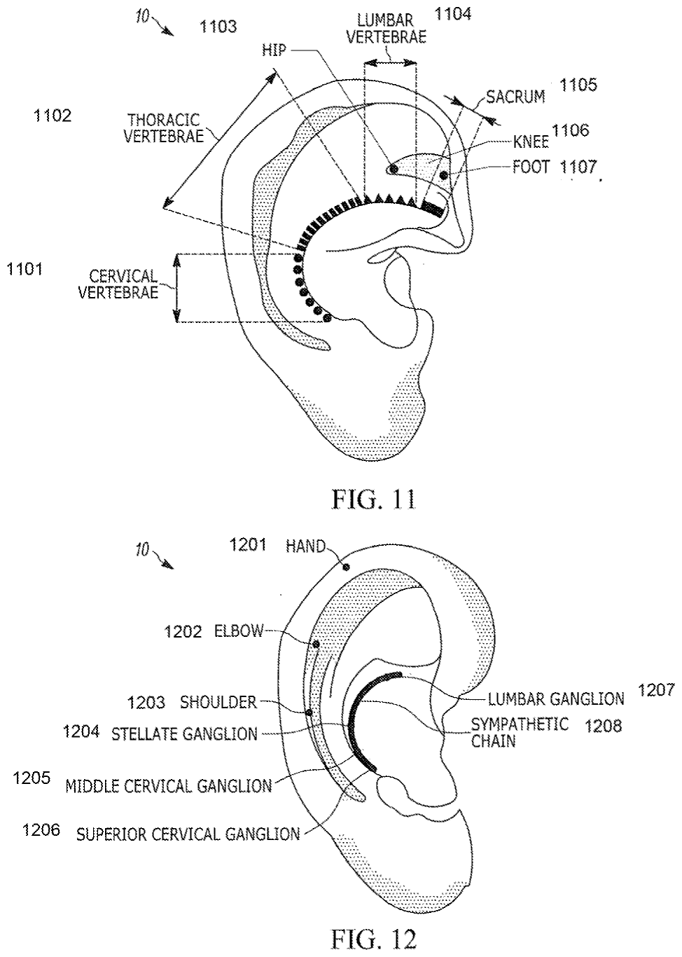

FIGS. 9, 10, 11, and 12 disclose treatments on zones 3 and 4, as depicted in FIG. 6C, that correspond to portions of the body developed in the embryonic mesoderm germ layer. Specifically, FIG. 9 discloses a section of the ear 901 that treats the hand and fingers; a section 902 that treats the wrist; a section 903 that treats the tongue; a section 904 that treats the forearm; a section 905 that treats the dermis; a section 906 that treats the elbow; a section 907 that treats the upper arm; a section 908 that treats the shoulder; a section 909 that treats the thumb; a section 910 that treats the adrenals; a section 911 that treats the foot; a section 912 that treats the leg; a section 913 that treats the knee; a section 914 that treats the thigh; a section 915 that treats the hip; a section 916 that treats the diaphragm; and a section 917 that treats the rib cage. FIG. 10 discloses a section of the ear 1001 that treats the ureter; a section 1002 that treats the heart; a section 1003 that treats the scalp; a section 1004 that treats the pleura; a section 1005 that treats the peritoneum; a section 1006 that treats the kidney; a section 1007 that treats the uterus or prostate; a section 1008 that treats the spleen; and a section 1009 that treats the ovary or testicle. FIG. 11 discloses a section of the ear 1101 that treats the cervical vertebrae; a section 1102 that treats the thoracic vertebrae; a section 1103 that treats the hip; a section 1104 that treats the lumbar vertebrae; a section 1105 that treats the sacrum; a section 1106 that treats the knee; and a section 1107 that treats the foot. FIG. 12 discloses a section of the ear 1201 that treats the hand; a section 1202 that treats the elbow; a section 1203 that treats the shoulder; a section 1204 that treats the stellate ganglion; a section 1205 that treats the middle cervical ganglion; a section 1206 that treats the superior cervical ganglion; as section 1207 that treats the lumbar ganglion; and a section 1208 that treats the sympathetic chain.

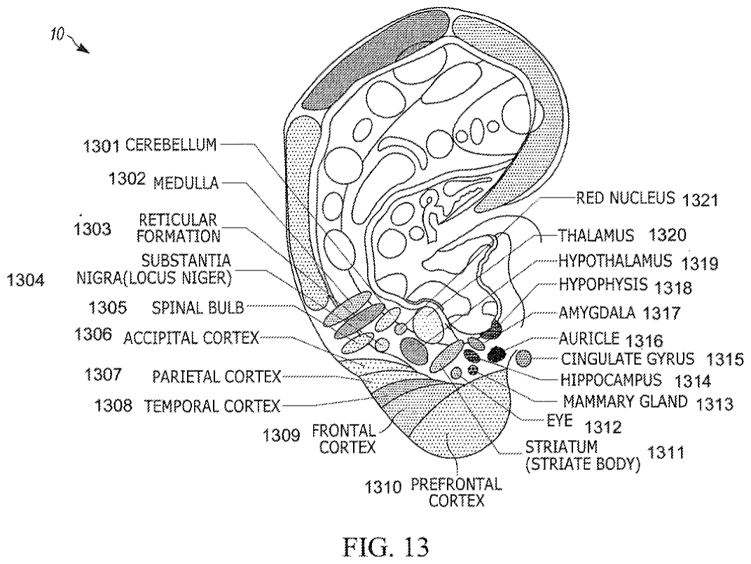

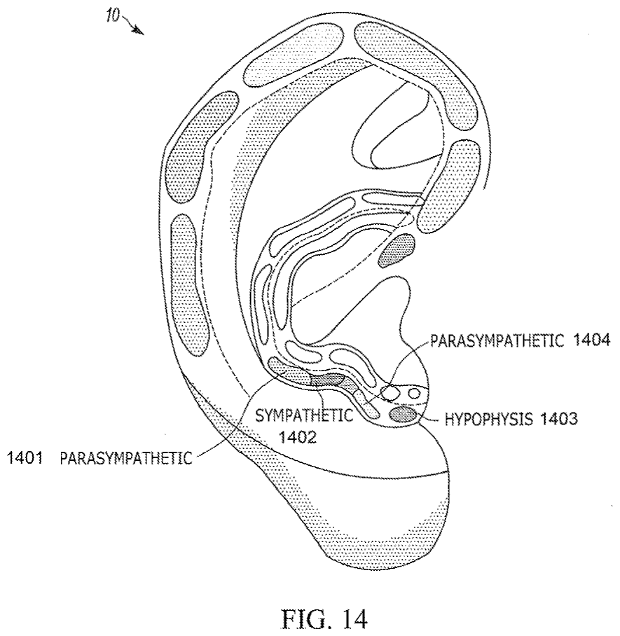

FIGS. 13 and 14 disclose treatments on zones 5 and 6, as depicted in FIG. 6C, that correspond to portions of the body developed in the embryonic ectoderm germ layer. Specifically, FIG. 13 discloses a section of the ear 1301 that treats the cerebellum; a section 1302 that treats the medulla; a section 1303 that treats the reticular formation; a section 1304 that treats the nigra/locus niger; a section 1305 that treats the spinal bulb; a section 1306 that treats the accipital cortex; a section 1307 that treats the parietal cortex; a section 1308 that treats the temporal cortex; a section 1309 that treats the frontal cortex; a section 1310 that treats the prefrontal cortex; a section 1311 that treats the striatum/striate body; a section 1312 that treats the eye; a section 1313 that treats the mammary gland, a section 1314 that treats the hippocampus; a section 1315 that treats the cingulate gyms; a section 1316 that treats the auricle; a section 1317 that treats the amygdala; a section 1318 that treats the hypophysis/pituitary; a section 1319 that treats the hypothalamus; a section 1320 that treats the thalamus, and a section 1321 that treats the red nucleus. FIG. 14 discloses a sections of the ear 1401 and 1404 that treat the parasympathetic nervous system; a section 1402 that treats the sympathetic nervous system; and a section 1403 that treats the hypophysis/pituitary.

A non-exhaustive list of zones of the ear treated, and the corresponding portions of the body affected, is further summarized in Table I below:

TABLE I

| Zone | Anatomy of the Ear Targeted | Portion of Body Affected |
|---|---|---|
| Zone 1 | Tragus | Cortisol point |
| Zone 1 | Tragus | ACTH point |
| Zone 1 | Tragus | Hunger point |
| Zone 1 | Tragus | TSH (thyroid stimulating point) |
| Zone 2 | Upper Concha | Bladder, Colon, Liver, Gallbladder, Small |
| | | Intestine, Urethra |
| Zone 2 | Lower Concha | Thymus, Lung, Stomach, Esophagus, Bronchial |
| | | Tubes |
| Zone 3 | Root of the Helix | Ovary, Testicle |
| Zone 3 | Ascending Limb of the Helix | Uterus, Prostate, Suprarenal Kidney, Ureter, |
| | | Allergy Point |
| Zone 3 | Body of the Helix | Tongue, Scalp |
| Zone 3 | Tail of the Helix | Pleura, Derma |
| Zone 4 | Anti Helix - Scaphoid Fossa | Hands, Wrist, Forearm, Elbow, Arm, Shoulder |
| Zone 4 | Anti Helix - Navicular Fossa | Foot, Leg, Knee, Thigh, Hip |
| Zone 4 | Anti Helix - Apex Upper Third | Lumbar spine, Spleen, Heart, Circulatory System |
| Zone 4 | Anti Helix - Middle Third | Thoracic Spine, Heart, Peritoneum, Circulatory |
| | | System |
| Zone 4 | Anti Helix - Lower Third | Cervical Spine, Peritoneum, Circulatory System |
| Zone 4 | Anti Helix - Superior Root | Thumb |
| Zone 4 | Anti Helix | Diaphragm, Ribs |
| Zone 5 | Antitragus | Thalamus, Hypothalamus, Parasympathetic, |
| | | Sympathetic (ANS) Thymus |
| Zone 5 | Antitragus - inter tragal notch | Hypophysis, Parathyroid, Thyroid |
| Zone 6 | Lobe of the ear | Eye, Prefrontal Cortex, Temporal Cortex, Parietal |
| | | Cortex, Occipital Cortex, Cerebellum, |
| | | Hippocampus, Red Nucleus |

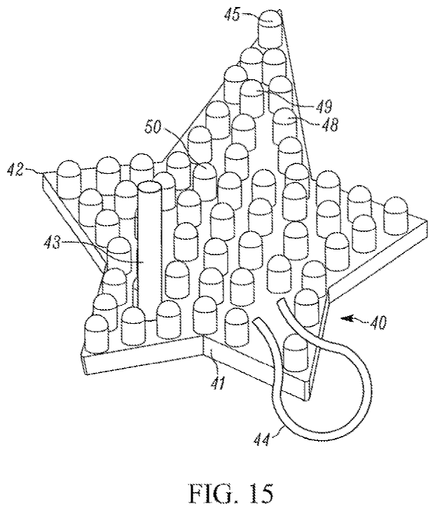

A preferred embodiment of the auriculotherapy device 40 is depicted in FIG. 15. Auriculotherapy device 40 has a base 41. Base 41 serves as the platform on which the portions of the auriculotherapy device 40 that provide a therapeutic effect, as well as the portions which connect the auriculotherapy device 40 to the ear, are attached. The base can have any shape that defines a cross-sectional area including, but not limited to a diamond, a square, and a circle. In the embodiment depicted in FIG. 15, the base 41 is star-shaped. The base 41 has a length between about 15.0 mm to about 30.0 mm and a width between about 10.0 mm to about 25.0 mm. The base 41 can be manufactured from any material that is commonly used for close contact with skin including, but not limited to platinum, 24 karat gold, 14 karat gold, surgical steel, and sterling silver.

The base 41 further defines a first side 42. Attached to first side 42 are connection pieces 43 and 44. Connection pieces 43 and 44 secure the auriculotherapy device 40 to the ear by fitting through an ear piercing and clipping to the ear, respectively. Connection pieces 43 and 44 may be a post, a pin, or any other apparatus that can be fit through an ear piercing. Alternatively, connection pieces 43 and 44 may be a clamp, a clip, a magnet or any other apparatus that does not require insertion through an ear piercing yet attaches the device to the ear. Connection pieces 43 and 44 may also contain portions which fit through an ear piercing as well as portions which otherwise attach to the ear. As depicted in FIG. 15, connection pieces 43 and 44 may be a combination of these devices. Connection pieces 43 and 44 can be manufactured from any material that is commonly used for close contact with skin including, but not limited to platinum, 24 karat gold, 14 karat gold, surgical steel, and sterling silver. Additionally, the material from which connection pieces 43 and 44 are manufactured can differ from that of other portions of auriculotherapy device 40.

Extending from first side 42 are a plurality of therapeutic projections 45. Therapeutic projections 45 extend from first side 42 at an angle that is preferably between about 45° to about 90°, and more preferably 90°. Therapeutic projections 45 press up against and apply pressure to specific acupressure points on the ear, providing a therapeutic effect. It has been determined that a large number of small diameter projections provide a superior engagement of the acupressure points and in turn provide a superior therapeutic effect. In the embodiment disclosed in FIG. 15, first side 42 preferably has at least fifty therapeutic projections 45. Therapeutic projections 45 can be manufactured from any material that is commonly used for close contact with skin including, but not limited to platinum, 24 karat gold, 14 karat gold, surgical steel, and sterling silver. Additionally the material from which therapeutic projections 45 are manufactured can differ from that of other portions of auriculotherapy device 40. The distance between each therapeutic projection is between about 0.75 mm to about 2.0 mm.

As shown in FIG. 17, therapeutic projections 45 preferably have a body 46 having a circular cross section, however other cross sectional configurations are contemplated, including but not limited to hexagonal, triangular, and square cross sections. Therapeutic projections 45 further include a top portion 47 for engaging an acupressure point of the ear. Top portion 47 is preferably rounded or hemispherical in shape, however other configurations are also contemplated, including but not limited to a pointed top portion or a flat top portion. Therapeutic projections 47 have a diameter between about 0.5 mm to about 1.5 mm, and are preferably 0.81 mm. The distance between each therapeutic projection is between about 0.75 mm to 2.0 mm.

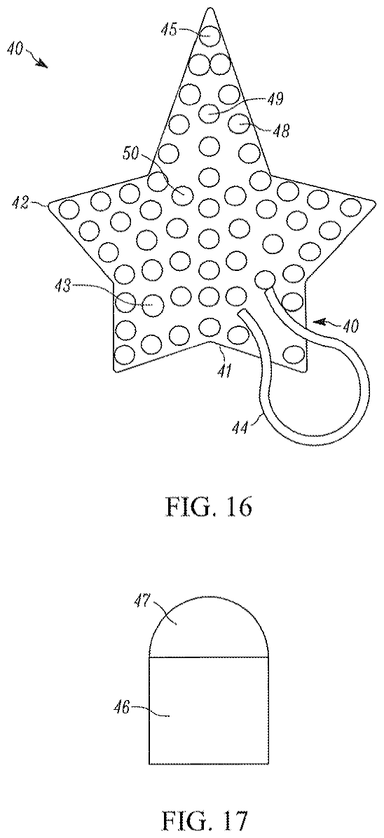

It has been determined that by varying the height of therapeutic projections 45, the auriculotherapy device 40 can better accommodate the contours of the ear and provide more effective therapeutic relief. In the embodiment best depicted in FIGS. 15 and 16, the outside edges of first side 42 defines a first row of therapeutic projections 48 having a height between about 2.0 mm to about 3.0 mm, preferably 2.35 mm. In the center of the preferred embodiment, the first side 3 further defines a second row of therapeutic projections 49 having a height between about 3.5 mm to about 4.5 mm, preferably 4.15 mm. Between first row of therapeutic projections 48 and second row of therapeutic projections 49 there is a third row of therapeutic projections 50 having a height between about 3.0 mm to about 4.0 mm, preferably 3.7 mm.

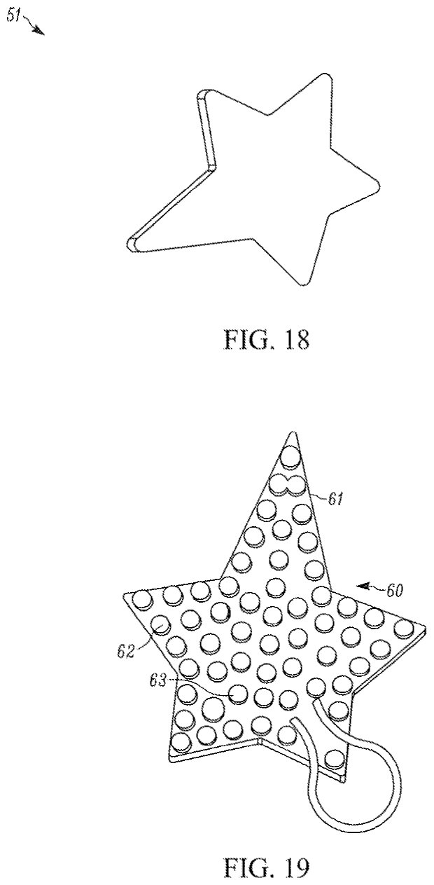

The base further defines a second side 51, which is depicted in FIG. 18. Second side 51 conceals therapeutic projections 45, such that to the outside observer auriculotherapy device 40 appears to resemble a common earring. Second side 51 may be decorated in a manner customary with known jewelry, and as such may contain adornments including but not limited to patterns, paints, metals, semi-precious and precious stones, as well as costume jewelry equivalents.

A second preferred embodiment 60 is depicted in FIG. 19. The second preferred embodiment discloses an auriculotherapy device 60 having a first side 61. The outside edges of first side 61 defines a first row of therapeutic projections 62 having a height between about 1.0 mm to about 2.0 mm, preferably 1.80 mm. Enclosed by said first row of therapeutic projections 62 is a second row of therapeutic projections 63 having a height between about 2.0 mm to 3.0 mm, preferably 2.80 mm.

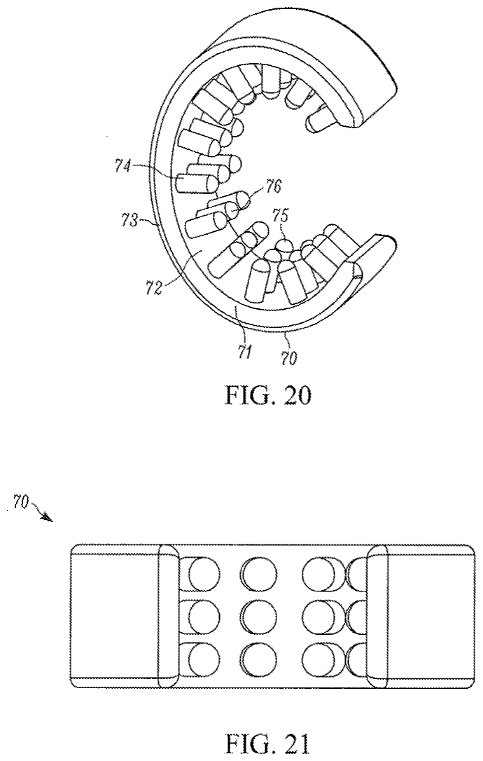

A third preferred embodiment 70 is depicted in FIGS. 20 and 21. As shown in FIG. 20, there is disclosed an auriculotherapy device 70 having a base 71. Base 71 has a first side 72 and a second side 73. Base 71 has a width between 7.0 mm and 11.0 mm, and a semi-major axis diameter between 10.0 mm and 15.0 mm. The first side 72 does not have a connection piece. Instead the base 71 is curved such that first side 72 engages the helix portion of the ear and establishes a pressure fit.

Extending from first side 72 are a plurality of therapeutic projections 74. Therapeutic projections extend at an angle preferably between about 45° to about 90° from first side 72, and more preferably extend 90° from first side 72. Therapeutic projections 35 target specific acupressure points on the ear, providing a therapeutic effect. In the embodiment disclosed in FIG. 21, first side 72 preferably has at least thirty-six therapeutic projections 74. The distance between each therapeutic projection is between about 0.75 mm to about 2.0 mm. As depicted in FIGS. 20 and 21, the outside edges of first side 72 define a first row of therapeutic projections 75 having a height between about 2.0 mm to about 3.0 mm, preferably 2.4 mm. In the center of the preferred embodiment, the first side 72 further defines a second row of therapeutic projections 76 having a height between about 2.5 mm to about 3.5 mm, preferably 2.8 mm.

Method of Use

An auriculotherapy device is placed near the portion of the ear corresponding to the acupressure point representing the desired therapy. Where the auriculotherapy device has a connection piece the auriculotherapy device can be placed at any portion of the ear to which the auriculotherapy device can be connected, including but not limited to the tragus, concha, helix, anti helix, antitragus and lobe of the ear. Where the auriculotherapy device does not contain a connection piece, the auriculotherapy device is pressure fit onto an edge of the ear such as the helix or the outer lobe. Once the auriculotherapy device is attached to the ear, the therapeutic projections engage the desired acupressure point. Since the therapeutic projections vary in height, the auriculotherapy device accommodates the contours of the ear, providing a superior engagement of the desired acupressure points. So long as the auriculotherapy device is connected to the ear, the therapeutic projections continue to engage the acupressure point.

### WORKING EXAMPLES

The following Examples provide a nonlimiting illustration of certain embodiments of the invention.

A first patient was provided with the auriculotherapy device depicted in FIGS. 20 and 21. The auriculotherapy device was positioned to engage the antihelix of the ear. Prior to receiving the device, the patient complained of chronic lower and mid back pain. Within hours after using the auriculotherapy device the patient reported a significant reduction in their lower and mid-back pain. After using the auriculotherapy device for seven days the patient reduced their consumption of pain medication from 30 mg/day to 5 mg/day.

Although the invention has been described by reference to its preferred embodiment as is disclosed in the specification and drawings above, many more embodiments of the invention are possible without departing from the invention. Thus, the scope of the invention should be limited only by the appended claims.

What is claimed is:

1. A device for providing therapeutic pressure to an ear, said device comprising:
a base, wherein said base has a first side;
wherein said first side of said base has n therapeutic projections extending from said first side of said base; and
wherein n≥2.

2. The device of claim 1, wherein said base has a second side opposite said first side.

3. The device of claim 1, wherein said therapeutic projections extend from said first side of said base at an angle between about 45° and about 90°.

4. The device of claim 1, wherein said device is formed from a material selected from the group consisting of platinum, 24 karat gold, 14 karat gold, surgical steel, and sterling silver.

5. The device of claim 1, wherein said one or more therapeutic projections comprise a cylindrical base portion and a hemispherical top portion.

6. The device of claim 1, wherein said one or more therapeutic projections comprises a first row of therapeutic projections and a second row of therapeutic projections.

7. The device of claim 6, wherein said first row of therapeutic projections has a height between about 1.0 mm to about 3.0 mm, and said second row of therapeutic projections has a height of between about 2.0 mm to about 4.5 mm.

8. The device of claim 7, wherein said one or more therapeutic projections comprises a third row of therapeutic projections, wherein said third row of projections has a height between about 3.0 mm and about 4.0 mm.

9. The device of claim 1, wherein said one or more therapeutic projections has a diameter between about 0.5 mm to about 1.5 mm.

10. The device of claim 1, wherein said device further comprises a connection piece; wherein said connection piece is attached to said first side of said base.

11. The device of claim 1, wherein said base is curvilinear; and wherein said base engages the helix portion of said ear through a pressure-fit.

12. The device of claim 6, wherein said first row of therapeutic projections is separated from said second row of therapeutic projections by a distance between about 0.5 mm to about 2.0 mm.

13. The device of claim 1, wherein n≥15

14. The device of claim 1, wherein n≥30

15. The device of claim 1, wherein n≥50

16. A method of providing auriculotherapy, said method comprising the steps of:
attaching a first device to a first portion of the ear;
wherein said first device comprises a base;
wherein said base of said first device has a first side;
wherein said first side of said base of said first device has n therapeutic projections extending from said first side of said base; and
wherein n≥2.

17. The method of claim 16, wherein said first portion of the ear is selected from the group consisting of the Tragus, the Upper Concha, the Lower Concha, the Root of the Helix, the Ascending Limb of the Helix, the Body of the Helix, the Tail of the Helix, the Anti Helix, the Anti Helix—Scaphoid Fossa, the Anti Helix—Navicular Fossa, the Anti Helix—Apex Upper Third, the Anti Helix—Middle Third, the Anti Helix—Lower Third, the Anti Helix—Superior Root, the Antitragus, the Antitragus—Inter Tragal Notch, and Lobe of the Ear.

18. The method of claim 16, wherein said first portion of the ear is the antihelix; and wherein n≥36.

19. The method of claim 16, said method further comprising the steps of:
attaching a second device to a second portion of the ear;
wherein said second device comprises a base;
wherein said base of said second device has a first side;
wherein said first side of said base of said second device has m therapeutic projections extending from said first side of said base; and
wherein m≥2.

20. The method of claim 19, wherein m≥36;
wherein said first portion of the ear is the tragus; and
wherein said section portion of the ear is the helix.

21. The method of claim 16, wherein said first portion of the ear comprises the helix and antihelix.
